(19) United States
(12) Patent Application Publication
(10) Pub. No.: US 2026/0243862 A1
(43) Pub. Date: Aug. 20, 2026

(54) CARRIER PHASE POSITIONING MEASUREMENTS

(71) Applicant: Apple Inc., Cupertino, CA (US)

(72) Inventors: Oghenekome Oteri, San Diego, CA (US); Chunxuan Ye, San Diego, CA (US); Weidong Yang, San Diego, CA (US); Chunhai Yao, Beijing (CN); Wei Zeng, Saratoga, CA (US); Dawei Zhang, Saratoga, CA (US); Hong He, San Jose, CA (US); Seyed Ali Akbar Fakoorian, San Diego, CA (US); Sigen Ye, Whitehouse Station, NJ (US); Huaning Niu, San Jose, CA (US); Yushu Zhang, Beijing (CN)

(21) Appl. No.: 18/995,042

(22) PCT Filed: Jul. 22, 2022
(86) PCT No.: PCT/CN2022/107256

§ 371 Date: Jan. 15, 2025

(51) Int. Cl. G01S 5/10; G01S 5/00; G01S 5/02

(52) U.S. Cl. CPC G01S 5/10; G01S 5/0036; G01S 5/0226

(57) ABSTRACT

A user equipment (UE) includes a transceiver and a processor. The processor is configured to transmit, via the transceiver, UE capability information indicating at least one capability of the UE regarding carrier phase positioning (CPP) measurements. In accord with the UE capability information, the processor is configured to: receive one or more downlink (DL) positioning reference signal (PRS) configurations or one or more uplink (UL) sounding reference signal (SRS) configurations. The processor is configured to perform the CPP measurements on the plurality of DL PRS symbols, or transmit, to the base station, one or more UL SRSs based on the one or more UL SRS configurations. The one or more DL PRS configurations include a plurality of DL PRS symbols. The one or more UL SRS configurations and the one or more DL PRS configurations are adapted for the CPP measurements.

### TECHNICAL FIELD

This application relates generally to wireless communication systems, including methods and systems for carrier phase positioning based measurements.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 602.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In some deployments, the E-UTRAN may also implement NR RAT. In some deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 illustrates an example configuration of positioning reference symbols (PRSs) for traditional time based positioning and carrier phase based positioning, according to embodiments described herein.

FIG. 3 illustrates an example flow-chart of operations that may be performed by a UE, according to embodiments described herein.

FIG. 4 illustrates an example flow-chart of operations that may be performed by a base station, according to embodiments described herein.

FIG. 5 illustrates an example flow-chart of method operations for CPP measurements, according to embodiments described herein.

FIG. 6 illustrates an example architecture of a wireless communication system, according to embodiments described herein.

FIG. 7 illustrates a system for performing signaling between a wireless device and a network device, according to embodiments described herein.

### DETAILED DESCRIPTION

In the present disclosure, various embodiments are related to systems and methods for positioning measurements. In particular, the embodiments described herein are related to performing positioning measurements based on carrier phase information. Traditional timing-based positioning measurements using time of arrival (ToA) and/or time or direction of arrival (TDoA) may have limitations because of signal bandwidth, receiver resolution, and complexity associated with various algorithms, for example, multiple signal classification (MUSIC), estimation of signal parameters via rotational invariance techniques (ESPRIT), and/or space-alternating generalized expectation-maximization (SAGE).

Another alternative to the traditional timing-based positioning measurement is a carrier phase ranging method, which uses a carrier phase of a measurement signal to extract propagation distance information between a source of the measurement signal and a receiver of the measurement signal. However, the carrier phase ranging method may also have limitations, for example, the carrier phase ranging method may not be suitable for multi-path and/or non-line-of-sight (NLOS) environments. In addition, carrier phase positioning measurements have unknown integer ambiguity problems in which a total number of whole cycles of the measurement signal on a propagation path from the source of the measurement signal to the receiver of the measurement signal is unknown and can be determined with some level of complexity,, but only a fractional cycle of the measurement signal can be verified easily and accurately.

Further, for the traditional timing-based positioning measurements and/or carrier phase ranging method, clocks at the transmitters and the receiver are needed to be synchronized. In other words, the transmitter and the receiver clocks are required to generate the same phase of the carrier at the same instance of time. The carrier phase that is being received by the receiver may lag behind the carrier phase that the receiver may be generating, and this lag may correspond with the time of propagation by the measurement signal as the carrier phase has a linear variation with time. As such, clock synchronization offsets and/or errors may also cause problems.

For measuring the distance between a transmitter and a receiver using carrier phases like those used in real-time kinematic (RTK) and/or precise point positioning (PPP), absolute ambiguity resolution is required, so that carrier phase based positioning can be applied for position determination. Further, carrier phase based positioning needs at least one good initial position result derived from ToA measurements and a non-static setup. While resolving relative ambiguities between two consecutive measurements, which may be a few milliseconds apart, a speed of a moving object may be indicated, and/or may be used for carrier phase smoothing. Accordingly, while using the carrier phase ranging method, only a fraction of a wavelength can be measured without executing an ambiguity resolution for each measurement step in time. Therefore, only plus or minus half a wavelength can be distinguished successfully before a cycle slip occurs. Based on this, the maximum speed of an object may be calculated. However, at higher carrier frequency, maximum velocity, or speed that can be measured may be lower. Accordingly, the carrier phase ranging method may not be beneficial in frequency range-2 (FR2).

Thus, existing carrier phase ranging methods are unsuitable for 5G NR for positioning determination, and/or velocity measurement. Various embodiments in the present disclosure provide solutions so that the carrier phase ranging method may be used for positioning determination, and/or velocity measurement for 5G NR. Further, various embodiments described herein may be used for UE-based and/or UE-assisted positioning using physical layer measurements and/or physical layer procedures based on reference signals (such as downlink (DL) positioning reference signal (PRS) and/or uplink (UL) sounding reference signal (SRS)) without introducing any new reference signal. However, new reference signals may be used without departing from the scope of the various embodiments as described herein.

Reference will now be made in detail to representative embodiments/aspects illustrated in the accompanying drawings. The following description is not intended to limit the embodiments to one preferred embodiment. On the contrary, it is intended to cover alternatives, combinations, modifications, and equivalents as can be included within the spirit and scope of the described embodiments as defined by the appended claims.

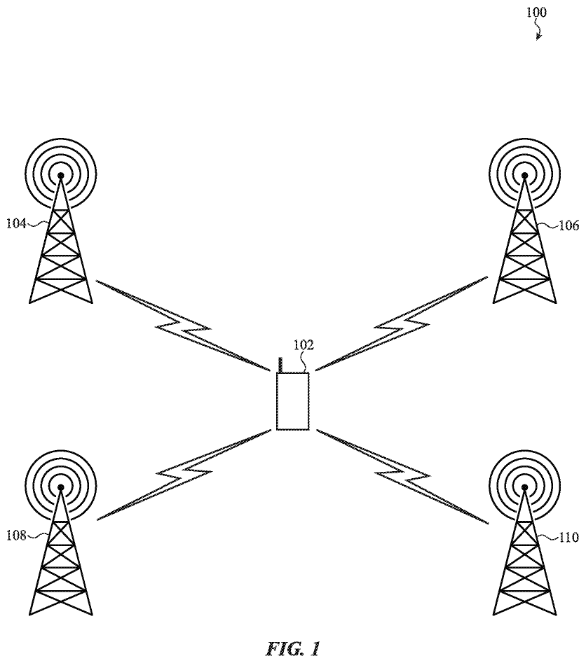

FIG. 1 shows an example wireless communication system, according to embodiments described herein. As shown in FIG. 1, a wireless communication system 100 may include base stations 104, 106, 108, and 110, and a UE 102. In some embodiments, the base stations 104, 106, 108, and 110 may be an eNb, an eNodeB, a gNodeB, or an access point (AP) in a radio access network (RAN) and may support one or more radio access technologies, such as 4G, 5G, 5G new radio (5G NR), and so on. The UE 102 may be a phone, a smart phone, a tablet, a smartwatch, an Internet-of-Things (IOT), and so on. While the UE 102 is shown to be communicatively connected with four base stations 104, 106, 108, and 110 in FIG. 1, the embodiments described herein may require the UE 102 to be communicatively coupled with at least three base stations.

The UE 102, communicatively coupled with at least three base stations of 104, 106, 108, and 110, may receive PRS for the UE 102 to perform downlink time difference of arrival (DL-TDoA) measurements, DL angle of departure (DL-AoD) measurements, and/or round-trip time (RTT) measurements on the PRS (also referenced herein as DL PRS) received from each of the at least three base stations of 104, 106, 108, and 110. Similarly, the UE 102 may transmit, to each of the at least three base stations of 104, 106, 108, and 110, SRS (also referenced herein as UL SRS). Each of the at least three base stations of 104, 106, 108, and 110 may perform UL-TDoA measurements, UL angle of arrival (UL-AOA) measurements, and RTT measurements on the received UL SRS. The UE 102, and/or each of the at least three base stations of 104, 106, 108, and 110 may report the performed measurements to a location server (not shown). The location server may determine the position of the UE 102 and/or each of the at least three base stations 104, 106, 108, and 110 based on the received measurements.

As described herein, in accordance with some embodiments, the DL PRS, and/or UL SRS, may be used for carrier phase measurements, in addition, or as an alternate to, traditional timing-based positioning measurements. By way of a non-limiting example, carrier phase measurements may include carrier phase of the signal on arrival (CPoA) measurements, and/or carrier phase difference of the signal on arrival (CPDoA) measurements. The DL PRS and/or UL SRS are transmitted at a long transmission period. Accordingly, the DL PRS and/or UL SRS may not always be available for applications that require a precise position determination and/or continuous monitoring of the precise position.

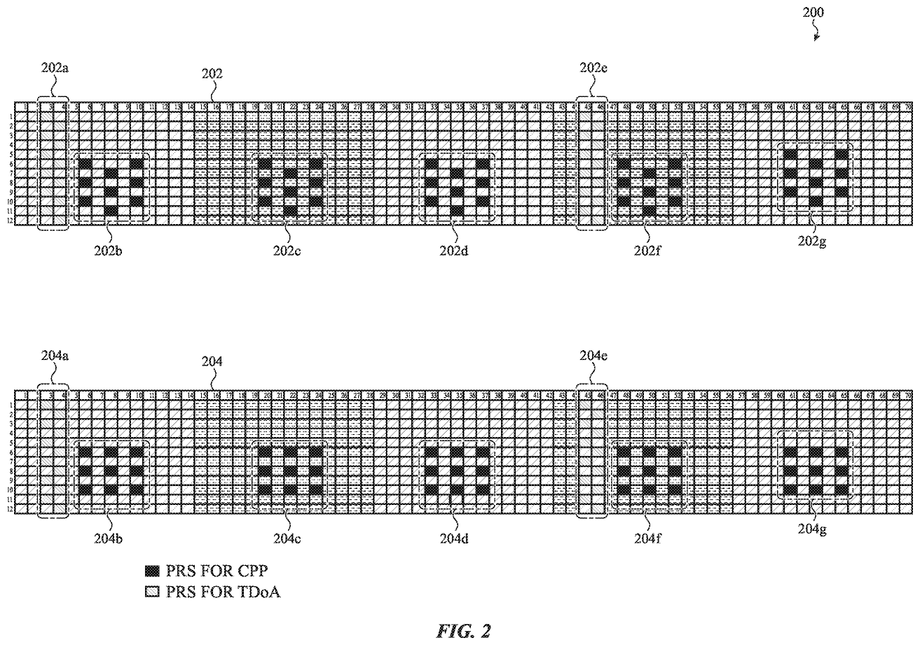

FIG. 2 illustrates an example configuration of positioning reference symbols (PRSs) for traditional time based positioning and carrier phase based positioning, according to embodiments described herein. In particular, the example configuration of PRSs for the traditional time based positioning and carrier phase based positioning shown in diagram 200 may be used for precise position determination and/or continuous monitoring of the precise position.

In some embodiments, a dedicated PRS configuration with multiple symbols in a slot may be transmitted to the UE 102 by a base station, such as the base station 104, 106, 108, and/or 110. By way of a non-limiting example, multiple symbols in the slot may have a gap between each symbol of the multiple symbols in the slot. In some embodiments, as shown in an example configuration 202, symbols of a radio signal frame are shown along a horizontal axis (or a time axis), and subcarriers of the radio signal frame are shown along a vertical axis (or a frequency axis). In the example configuration 202, twelve subcarriers are shown along the vertical axis forming one physical resource block (PRB). In the example configuration 202, PRS for CPP are shown as 202b, 202c, 202d, 202f, and 202g, and PRS for traditional timing-based positioning measurements are shown as 202a and 202e. As shown in the example configuration 202, PRS for CPP has higher periodicity in comparison with PRS for the traditional timing-based positioning measurements. By way of a non-limiting example, PRS for CPP may have a periodicity of 1 slot instead of a minimum of 4 slots. Accordingly, PRS for CPP may be almost always available as the PRS for CPP are present in each slot. Additionally, or alternatively, in some embodiments, PRS symbols for CPP may not be in each slot but may have a periodicity of two slots, and PRS symbols for non-CPP may have a periodicity of four slots. In other words, PRS symbols for CPP may have a higher periodicity in comparison with PRS symbols for non-CPP.

Another example configuration 204 may similarly have PRS for CPP as shown in FIG. 2 as 204b, 204c, 204d, 204f, and 204g, and PRS for traditional timing-based positioning measurements may be shown as 204a and 204e. Again, as shown in the example configuration 204, PRS for CPP has a higher periodicity in comparison with PRS for traditional timing-based positioning measurements. By way of a non-limiting example, PRS for CPP may have a periodicity of 1 slot instead of a minimum of 4 slots.

Accordingly, PRS for CPP may be almost always available as the PRS for CPP are present in each slot. Further, as shown in FIG. 2 as 202b, 202c, 202d, 202f, 202g, 204b, 204c, 204d, 204f, and/or 204g, PRS for CPP measurement in each slot may have a gap of at least one symbol between two symbols. Thus, the PRS (or DL PRS) configurations may be adapted for CPP measurements.

In some embodiments, the PRS configurations may be configurations on a sub-slot time periodicity level. In other words, the PRS configurations may include PRS for CPP measurements at a sub-slot level by indicating a number of PRS for CPP measurements on each sub-slot (for example, each half slot). By way of a non-limiting example, a different number of PRS for CPP measurements may be allocated in each sub-slot.

In some embodiments, the PRS configuration may describe PRS symbols allocated in a comb-based pattern in time. For example, PRS symbols for CPP measurements in 202b, 202c, 202d, 202f, 202g, 204b, 204c, 204d, 204f, and/or 204g are allocated in a comb-based pattern. Accordingly, PRS symbols for CPP measurements when allocated in a comb-based pattern may be useful or beneficial when carrier phase measurements are not required to be performed at a specific frequency. However, a non-comb based pattern may be specified when carrier phase measurements are to be performed at a particular frequency or subcarrier level.

In some embodiments, the PRS configuration may specify different bandwidths for PRS symbols for CPP measurements and PRS symbols for traditional timing-based positioning measurements. As a result, the PRS configuration may have a dedicated BW for CPP measurements and the traditional timing-based positioning measurements.

In some embodiments, a single PRS set configuration may support both CPP measurements and traditional timing-based positioning measurements. A single PRS set configuration may include multiple sub-configurations. For example, one sub-configuration related to a traditional timing-based positioning measurement may have a larger periodicity and/or a frequency bandwidth in comparison with a periodicity and/or frequency bandwidth for CPP measurements. By way of a non-limiting example, values for the periodicity and/or frequency bandwidth for the sub-configuration for CPP measurements may be a subset or a factor of values for the periodicity and/or frequency bandwidth for sub-configuration for traditional timing-based positioning measurements.

In some embodiments, multiple PRS configurations, and each PRS configuration of the multiple configurations having separate resources for CPP measurements and traditional timing-based positioning measurements, may be transmitted to a UE. In other words, in a single slot, PRS for either CPP measurements or traditional timing-based positioning measurements may exist, but not both. However, a resource for CPP measurement and a resource for traditional timing-based positioning measurements may use the same or a different frequency layer or subcarrier for the PRS. Radio resource control (RRC) signaling may be used to indicate a specific resource set that is to be used for CPP measurements.

In some embodiments, to avoid a clash with symbols for other purposes, PRS for CPP measurements may be symbols that are reserved for use by another UE. Other signals for the UE may skip the PRS.

Accordingly, various example PRS configurations shown in FIG. 2 describe PRS adapted to accommodate regular or more frequent CPP measurements. Similar to PRS configurations, SRS (or UL SRS) configurations may be adapted to accommodate regular or more frequent CPP measurements.

In some embodiments, a dedicated SRS configuration with multiple SRS symbols in a slot may be transmitted to the UE 102 by a base station, such as the base stations 104, 106, 108, and/or 110. By way of a non-limiting example, multiple SRS symbols in the slot may have a gap between each symbol of the multiple symbols in the slot. In some embodiments, SRS symbols for CPP have a higher periodicity in comparison with SRS symbols for the traditional timing-based positioning measurements. By way of a non-limiting example, SRS symbols for CPP may have a 1 slot periodicity or a sub-slot periodicity. Accordingly, SRS symbols for CPP may be almost always available as the SRS symbols for CPP are present in each slot, or each sub-slot. Additionally, or alternatively, in some embodiments, SRS symbols for CPP may not be in each slot or sub-slot, but may have a higher periodicity in comparison with SRS symbols for non-CPP.

In some embodiments, SRS symbols for CPP measurement in each slot or sub-slot may have a gap of at least one symbol between two symbols. Thus, the SRS (or UL SRS) configurations may be adapted for CPP measurements.

In some embodiments, the SRS configurations on a sub-slot time periodicity level may include SRS symbols for CPP measurements at a sub-slot level by indicating a number of SRS symbols for CPP measurements on each sub-slot (for example, each half slot). By way of a non-limiting example, a different number of SRS symbols for CPP measurements may be allocated in each sub-slot.

In some embodiments, the SRS configuration may describe SRS symbols allocated in a comb-based pattern in time. Accordingly, SRS symbols for CPP measurements when allocated in a comb-based pattern may be useful or beneficial when carrier phase measurements are not required to be performed at a specific frequency. However, a non-comb based pattern may be specified when carrier phase measurements are to be performed at a particular frequency or subcarrier level.

In some embodiments, the SRS configuration may specify different bandwidths for SRS symbols for CPP measurements and SRS symbols for traditional timing-based positioning measurements. As a result, the SRS configuration may have a dedicated BW for CPP measurements and the traditional timing-based positioning measurements.

In some embodiments, a single SRS set configuration may support both CPP measurements and traditional timing-based positioning measurements. A single SRS set configuration may include multiple sub-configurations. For example, one sub-configuration related to traditional timing-based positioning measurements may have a larger periodicity and/or frequency bandwidth in comparison with a periodicity and/or frequency bandwidth for CPP measurements. By way of a non-limiting example, values for the periodicity and/or frequency bandwidth for the sub-configuration for CPP measurements may be a subset or a factor of values for the periodicity and/or frequency bandwidth for sub-configuration for traditional timing-based positioning measurements.

In some embodiments, multiple SRS configurations, and each SRS configuration of the multiple configurations having separate resources for CPP measurements and traditional timing-based positioning measurements, may be transmitted to a UE. In other words, in a single slot, SRS for either CPP measurements or traditional timing-based positioning measurements may exist, but not both. Radio resource control (RRC) signaling may be used to indicate a specific resource set that is to be used for CPP measurements.

In some embodiments, to avoid a clash with symbols for other purposes, SRS symbols for CPP measurements may be symbols that are reserved for use by another UE. Other signals for the UE may skip the SRS symbols or resources.

In some embodiments, SRS configurations may allocate SRS symbols in a similar way as used for sidelink positioning SRS symbols.

As described herein, PRS and SRS configurations are transmitted to the UE 102 in accordance with UE capability information indicating at least one capability of the UE 102 regarding CPP measurements. In some embodiments, the at least one UE capability may describe the UE can estimate a UE position based on CPP measurements. By way of a non-limiting example, the UE, which supports position estimation based on CPP measurements, may also indicate in the same or an additional UE capability information message that the UE can support combined CPP measurements and traditional timing-based positioning measurements, and/or estimation of a change in position based on CPP measurements.

In some embodiments, estimation of a change in position (or a velocity) based on CPP measurements may be determined using PRS and/or SRS symbols transmitted using different center frequencies. By way of a non-limiting example, a center frequency may be near the end of a particular frequency band or bandwidth part assigned for the PRS and/or SRS symbols. In some embodiments, to limit overhead, the base station may transmit PRS and/or SRS configurations of different periodicities. For example, the base station may explicitly indicate to the UE maximum supported velocity, and/or implicitly allow maximum supported velocity. In some embodiments, the UE may provide feedback and a request for higher periodicity PRS and/or SRS symbols to support measurement or estimation of higher velocity.

In some embodiments, a UE may expect receiving PRS and/or SRS configurations describing PRS and/or SRS symbols to support the measurement of a particular velocity. In one example, the UE may indicate a velocity range, and the base station may transmit PRS and/or SRS configurations describing PRS and/or SRS symbols to support the velocity range indicated by the UE. In another example, the base station may adjust or trigger a correct or a different PRS and/or SRS configuration based on a current speed/velocity as estimated using embodiments described herein.

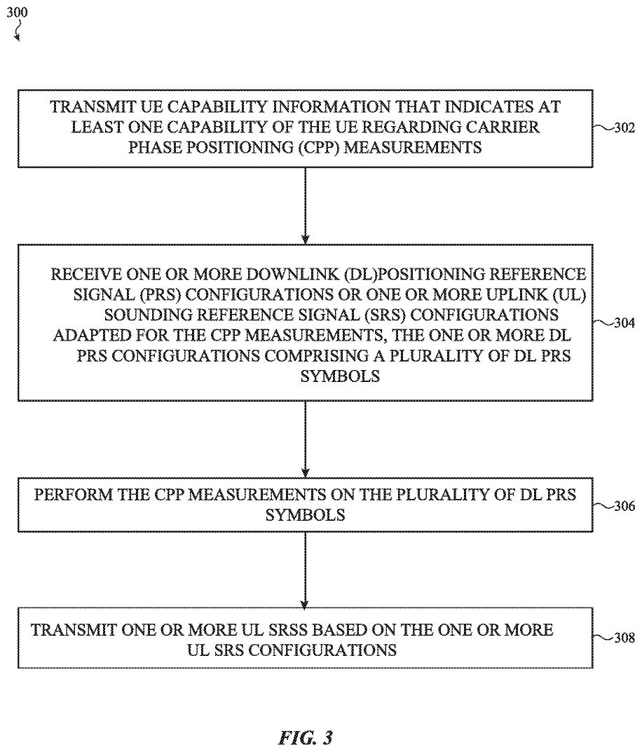

FIG. 3 illustrates an example flow-chart of operations that may be performed by a UE, according to embodiments described herein. As shown in a flow-chart 300, at 302, a UE may transmit UE capability information indicating at least one capability of the UE regarding CPP measurements. As described herein, the at least one capability of the UE may describe the UE can estimate a UE position based on CPP measurements. By way of a non-limiting example, the UE, which supports position estimation based on CPP measurements, may also indicate in the same or an additional UE capability information message that the UE can support combined CPP measurements and traditional timing-based positioning measurements, and/or estimation of a change in position based on CPP measurements.

At 304, in accordance with the UE capability information transmitted by the UE to the base station, the UE may receive one or more DL PRS configurations and/or one or more UL SRS configurations, as described herein, in accordance with some embodiments. The one or more DL PRS configurations and/or the one or more UL SRS configurations may be adapted for CPP measurements, as described herein, in accordance with some embodiments.

In some embodiments, when the UE has received the one or more DL PRS configurations at 304, at 306, the UE may perform CPP measurements on the DL PRS symbols received by the UE as specified in the one or more DL PRS configurations. The CPP measurements may include carrier phase of the signal on arrival (CPoA) measurements and carrier phase difference of the signal of arrival (CPDoA) measurements. In some embodiments, when the UE has received the one or more UL SRS configurations at 304, at 308, the UE may transmit one or more UL SRS symbols adapted for CPP measurements by the base station. The one or more UL SRS symbols are transmitted in accord with the one or more UL SRS configurations received by the UE at 302.

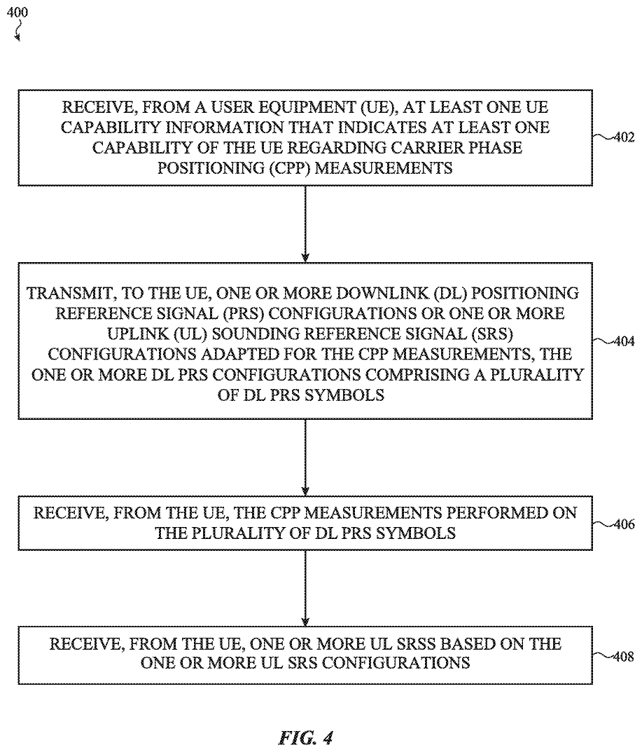

FIG. 4 illustrates an example flow-chart of operations that may be performed by a base station, according to embodiments described herein. As shown in a flow-chart 400, at 402, a base station may receive, from a UE, UE capability information indicating at least one capability of the UE regarding CPP measurements. As described herein, the at least one capability of the UE may describe the UE can estimate a UE position based on CPP measurements. By way of a non-limiting example, the UE, which supports position estimation based on CPP measurements, may also indicate in the same or an additional UE capability information message that the UE can support combined CPP measurements and traditional timing-based positioning measurements, and/or estimation of a change in position based on CPP measurements.

At 404, in accordance with the received UE capability information, the base station, may transmit, to the UE, one or more DL PRS configurations and/or one or more UL SRS configurations, as described herein, in accordance with some embodiments. The one or more DL PRS configurations and/or the one or more UL SRS configurations may be adapted for CPP measurements, as described herein, in accordance with some embodiments.

In some embodiments, when the base station has transmitted the one or more DL PRS configurations at 404, at 406, the base station may receive, from the UE, CPP measurements performed on the DL PRS symbols received by the UE as specified in the one or more DL PRS configurations. As described herein, the CPP measurements may include carrier phase of the signal on arrival (CPoA) measurements and carrier phase difference of the signal of arrival (CPDoA) measurements. In some embodiments, when the base station has transmitted the one or more UL SRS configurations at 404, at 408, the base station may receive, from the UE, one or more UL SRS symbols adapted for CPP measurements by the base station. The one or more UL SRS symbols are transmitted in accord with the one or more UL SRS configurations received by the UE at 402.

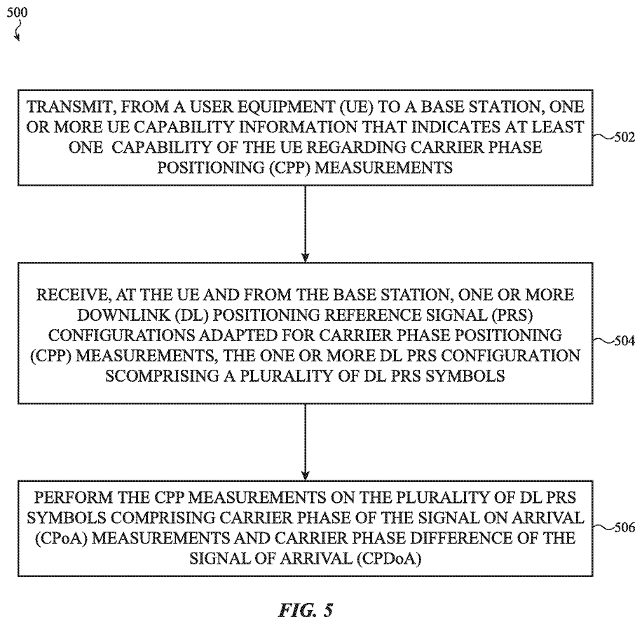

FIG. 5 illustrates an example flow-chart of method operations for CPP measurements, according to embodiments described herein. As shown in a flow-chart 500, at 502, a UE may transmit UE capability information indicating at least one capability of the UE regarding CPP measurements. As described herein, the at least one capability of the UE may describe the UE can estimate a UE position based on CPP measurements. By way of a non-limiting example, the UE, which supports position estimation based on CPP measurements, may also indicate in the same or an additional UE capability information message that the UE can support combined CPP measurements and traditional timing-based positioning measurements, and/or estimation of a change in position based on CPP measurements.

At 504, in accordance with the UE capability information transmitted by the UE to the base station, the UE may receive one or more DL PRS configurations adapted for CPP measurements, as described herein, in accordance with some embodiments.

At 506, the UE may perform CPP measurements on the DL PRS symbols received by the UE as specified in the one or more DL PRS configurations. The CPP measurements may include carrier phase of the signal on arrival (CPoA) measurements and carrier phase difference of the signal of arrival (CPDoA) measurements.

Embodiments contemplated herein include an apparatus having means to perform one or more elements of the method 300, 400, or 500. In the context of method 300, or 500, this apparatus may be, for example, an apparatus of a UE (such as a wireless device 702 that is a UE, as described herein). In the context of method 400, this apparatus may be, for example, an apparatus of a base station (such as a network device 720 that is a base station, as described herein).

Embodiments contemplated herein include one or more non-transitory computer-readable media storing instructions to cause an electronic device, upon execution of the instructions by one or more processors of the electronic device, to perform one or more elements of the method 300, 400, or 500. In the context of method 300, or 500, this non-transitory computer-readable media may be, for example, a memory of a UE (such as a memory 706 of a wireless device 702 that is a UE, as described herein). In the context of method 400, this non-transitory computer-readable media may be, for example, a memory of a base station (such as a memory 724 of a network device 720 that is a base station, as described herein).

Embodiments contemplated herein include an apparatus having logic, modules, or circuitry to perform one or more elements of the method 300, 400, or 500. In the context of method 300, or 500, this apparatus may be, for example, an apparatus of a UE (such as a wireless device 702 that is a UE, as described herein). In the context of method 400, this apparatus may be, for example, an apparatus of a base station (such as a network device 720 that is a base station, as described herein).

Embodiments contemplated herein include an apparatus having one or more processors and one or more computer-readable media, using or storing instructions that, when executed by the one or more processors, cause the one or more processors to perform one or more elements of the method 300, 400, or 500. In the context of method 300, or 500, this apparatus may be, for example, an apparatus of a UE (such as a wireless device 702 that is a UE, as described herein). In the context of the method 400, this apparatus may be, for example, an apparatus of a base station (such as a network device 720 that is a base station, as described herein).

Embodiments contemplated herein include a signal as described in or related to one or more elements of the method 300, 400, or 500.

Embodiments contemplated herein include a computer program or computer program product having instructions, wherein execution of the program by a processor causes the processor to carry out one or more elements of the method 300, 400, or 500. In the context of method 300, or 400, the processor may be a processor of a UE (such as a processor(s) 704 of a wireless device 702 that is a UE, as described herein), and the instructions may be, for example, located in the processor and/or on a memory of the UE (such as a memory 706 of a wireless device 702 that is a UE, as described herein). In the context of method 400, the processor may be a processor of a base station (such as a processor(s) 722 of a network device 720 that is a base station, as described herein), and the instructions may be, for example, located in the processor and/or on a memory of the base station (such as a memory 724 of a network device 720 that is a base station, as described herein).

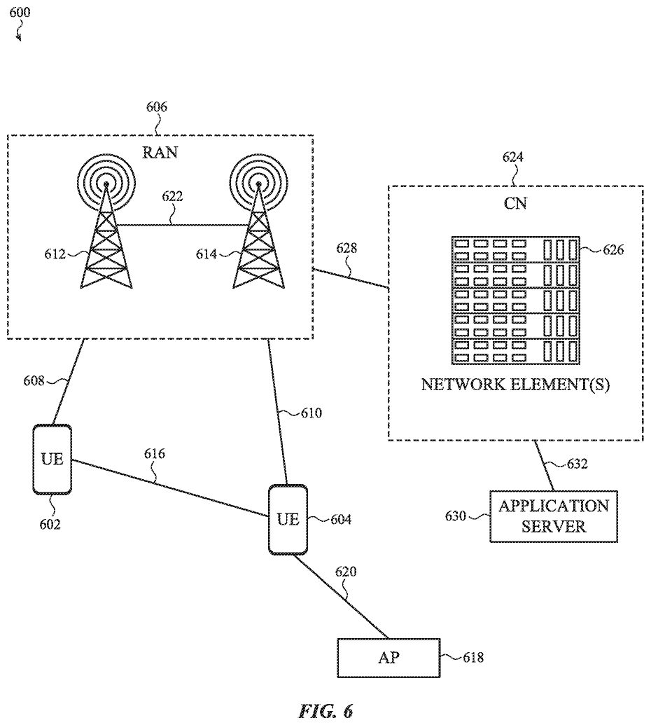

FIG. 6 illustrates an example architecture of a wireless communication system, according to embodiments described herein. The following description is provided for an example wireless communication system 600 that operates in conjunction with the LTE system standards and/or 5G or NR system standards as provided by 3GPP technical specifications.

As shown by FIG. 6, the wireless communication system 600 includes UE 602 and UE 604 (although any number of UEs may be used). In this example, the UE 602 and the UE 604 are illustrated as smartphones (e.g., handheld touchscreen mobile computing devices connectable to one or more cellular networks), but may also comprise any mobile or non-mobile computing device configured for wireless communication.

The UE 602 and UE 604 may be configured to communicatively couple with a RAN 606. In embodiments, the RAN 606 may be NG-RAN, E-UTRAN, etc. The UE 602 and UE 604 utilize connections (or channels) (shown as connection 608 and connection 610, respectively) with the RAN 606, each of which comprises a physical communications interface. The RAN 606 can include one or more base stations, such as base station 612 and base station 614, that enable the connection 608 and connection 610.

In this example, the connection 608 and connection 610 are air interfaces to enable such communicative coupling, and may be consistent with RAT(s) used by the RAN 606, such as, for example, an LTE and/or NR.

In some embodiments, the UE 602 and UE 604 may also directly exchange communication data via a sidelink interface 616. The UE 604 is shown to be configured to access an access point (shown as AP 618) via connection 620. By way of example, the connection 620 can comprise a local wireless connection, such as a connection consistent with any IEEE 602.11 protocol, wherein the AP 618 may comprise a Wi-Fi® router. In this example, the AP 618 may be connected to another network (for example, the Internet) without going through a CN 624.

In embodiments, the UE 602 and UE 604 can be configured to communicate using orthogonal frequency division multiplexing (OFDM) communication signals with each other or with the base station 612 and/or the base station 614 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 612 or base station 614 may be implemented as one or more software entities running on server computers as part of a virtual network. In addition, or in other embodiments, the base station 612 or base station 614 may be configured to communicate with one another via interface 622. In embodiments where the wireless communication system 600 is an LTE system (e.g., when the CN 624 is an EPC), the interface 622 may be an X2 interface. The X2 interface may be defined between two or more base stations (e.g., two or more eNBs and the like) that connect to an EPC, and/or between two eNBs connecting to the EPC. In embodiments where the wireless communication system 600 is an NR system (e.g., when CN 624 is a 5GC), the interface 622 may be an Xn interface. The Xn interface is defined between two or more base stations (e.g., two or more gNBs and the like) that connect to 5GC, between a base station 612 (e.g., a gNB) connecting to 5GC and an eNB, and/or between two eNBs connecting to 5GC (e.g., CN 624).

The RAN 606 is shown to be communicatively coupled to the CN 624. The CN 624 may comprise one or more network elements 626, which are configured to offer various data and telecommunications services to customers/subscribers (e.g., users of UE 602 and UE 604) who are connected to the CN 624 via the RAN 606. The components of the CN 624 may be implemented in one physical device or separate physical devices including components to read and execute instructions from a machine-readable or computer-readable medium (e.g., a non-transitory machine-readable storage medium).

In embodiments, the CN 624 may be an EPC, and the RAN 606 may be connected with the CN 624 via an S1 interface 628. In embodiments, the S1 interface 628 may be split into two parts, an S1 user plane (S1-U) interface, which carries traffic data between the base station 612 or base station 614 and a serving gateway (S-GW), and the S1-MME interface, which is a signaling interface between the base station 612 or base station 614 and mobility management entities (MMEs).

In embodiments, the CN 624 may be a 5GC, and the RAN 606 may be connected with the CN 624 via an NG interface 628. In embodiments, the NG interface 628 may be split into two parts, an NG user plane (NG-U) interface, which carries traffic data between the base station 612 or base station 614 and a user plane function (UPF), and the S1 control plane (NG-C) interface, which is a signaling interface between the base station 612 or base station 614 and access and mobility management functions (AMFs).

Generally, an application server 630 may be an element offering applications that use internet protocol (IP) bearer resources with the CN 624 (e.g., packet switched data services). The application server 630 can also be configured to support one or more communication services (e.g., VoIP sessions, group communication sessions, etc.) for the UE 602 and UE 604 via the CN 624. The application server 630 may communicate with the CN 624 through an IP communications interface 632.

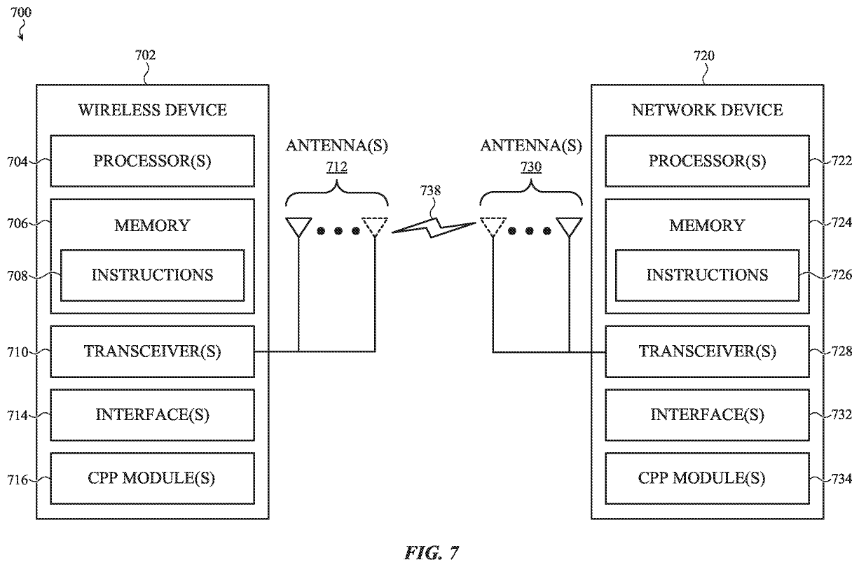

FIG. 7 illustrates a system 700 for performing signaling 738 between a wireless device 702 and a network device 720, according to embodiments described herein. The system 700 may be a portion of a wireless communication system as herein described. The wireless device 702 may be, for example, a UE of a wireless communication system. The network device 720 may be, for example, a base station (e.g., an eNB or a gNB) of a wireless communication system.

The wireless device 702 may include one or more processor(s) 704. The processor(s) 704 may execute instructions such that various operations of the wireless device 702 are performed, as described herein. The processor(s) 704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 702 may include a memory 706. The memory 706 may be a non-transitory computer-readable storage medium that stores instructions 708 (which may include, for example, the instructions being executed by the processor(s) 704). The instructions 708 may also be referred to as program code or a computer program. The memory 706 may also store data used by, and results computed by, the processor(s) 704.

The wireless device 702 may include one or more transceiver(s) 710 that may include radio frequency (RF) transmitter and/or receiver circuitry that use the antenna(s) 712 of the wireless device 702 to facilitate signaling (e.g., the signaling 738) to and/or from the wireless device 702 with other devices (e.g., the network device 720) according to corresponding RATs.

The wireless device 702 may include one or more antenna(s) 712 (e.g., one, two, four, or more). For embodiments with multiple antenna(s) 712, the wireless device 702 may leverage the spatial diversity of such multiple antenna(s) 712 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 702 may be accomplished according to precoding (or digital beamforming) that is applied at the wireless device 702 that multiplexes the data streams across the antenna(s) 712 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In some embodiments having multiple antennas, the wireless device 702 may implement analog beamforming techniques, whereby phases of the signals sent by the antenna(s) 712 are relatively adjusted such that the (joint) transmission of the antenna(s) 712 can be directed (this is sometimes referred to as beam steering).

The wireless device 702 may include one or more interface(s) 714. The interface(s) 714 may be used to provide input to or output from the wireless device 702. For example, a wireless device 702 that is a UE may include interface(s) 714 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 710/antenna(s) 712 already described) that allow for communication between the UE and other devices and may operate according to known protocols (e.g., Wi-Fi®, Bluetooth®, and the like).

The wireless device 702 may include a CPP module 716. The CPP module 716 may be implemented via hardware, software, or combinations thereof. For example, the CPP module 716 may be implemented as a processor, circuit, and/or instructions 708 stored in the memory 706 and executed by the processor(s) 704. In some examples, the CPP module 716 may be integrated within the processor(s) 704 and/or the transceiver(s) 710. For example, the CPP module 716 may be implemented by a combination of software components (e.g., executed by a DSP or a general processor) and hardware components (e.g., logic gates and circuitry) within the processor(s) 704 or the transceiver(s) 710.

The CPP module 716 may be used for various aspects of the present disclosure, for example, aspects of FIGS. 2, 3, and 5, from the UE perspective. The CPP module 716 may be configured to, for example, transmit UE capability information to a base station, as described herein, and perform CPP measurement operations, as described herein, in accordance with some embodiments.

The network device 720 may include one or more processor(s) 722. The processor(s) 722 may execute instructions such that various operations of the network device 720 are performed, as described herein. The processor(s) 722 may include one or more baseband processors implemented using, for example, a CPU, a DSP, an ASIC, a controller, an FPGA device, another hardware device, a firmware device, or any combination thereof configured to perform the operations described herein.

The network device 720 may include a memory 724. The memory 724 may be a non-transitory computer-readable storage medium that stores instructions 726 (which may include, for example, the instructions being executed by the processor(s) 722). The instructions 726 may also be referred to as program code or a computer program. The memory 724 may also store data used by, and results computed by, the processor(s) 722.

The network device 720 may include one or more transceiver(s) 728 that may include RF transmitter and/or receiver circuitry that use the antenna(s) 730 of the network device 720 to facilitate signaling (e.g., the signaling 738) to and/or from the network device 720 with other devices (e.g., the wireless device 702) according to corresponding RATs.

The network device 720 may include one or more antenna(s) 730 (e.g., one, two, four, or more). In embodiments having multiple antenna(s) 730, the network device 720 may perform MIMO, digital beamforming, analog beamforming, beam steering, etc., as has been described.

The network device 720 may include one or more interface(s) 732. The interface(s) 732 may be used to provide input to or output from the network device 720. For example, a network device 720 that is a base station may include interface(s) 732 made up of transmitters, receivers, and other circuitry (e.g., other than the transceiver(s) 728/antenna(s) 730 already described) that enables the base station to communicate with other equipment in a core network, and/or that enables the base station to communicate with external networks, computers, databases, and the like for purposes of operations, administration, and maintenance of the base station or other equipment operably connected thereto.

The network device 720 may include a CPP module 734. The CPP module 734 may be implemented via hardware, software, or combinations thereof. For example, the CPP module 734 may be implemented as a processor, circuit, and/or instructions 726 stored in the memory 724 and executed by the processor(s) 722. In some examples, the CPP module 734 may be integrated within the processor(s) 722 and/or the transceiver(s) 728. For example, the CPP module 734 may be implemented by a combination of software components (e.g., executed by a DSP or a general processor) and hardware components (e.g., logic gates and circuitry) within the processor(s) 722 or the transceiver(s) 728.

The CPP module 734 may be used for various aspects of the present disclosure, for example, aspects of FIGS. 2 and 4, from a base station perspective. The CPP module 734 may be configured to, for example, receive UE capability information, as described herein, and transmit one or more PRS and/or SRS configurations, for the UE to perform CPP measurement operations.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a transceiver; and
a processor configured to,
transmit, via the transceiver, UE capability information that indicates at least one capability of the UE regarding carrier phase positioning (CPP) measurements; and
in accord with the UE capability information:
receive, via the transceiver, one or more downlink (DL) positioning reference signal (PRS) configurations or one or more uplink (UL) sounding reference signal (SRS) configurations, the one or more DL PRS configurations or the one or more UL SRS configurations adapted for the CPP measurements, the one or more DL PRS configurations comprising a plurality of DL PRS symbols; and at least one of:
perform the CPP measurements on the plurality of DL PRS symbols, the CPP measurements comprising carrier phase of the signal on arrival (CPoA) measurements and carrier phase difference of the signal of arrival (CPDoA) measurements; or
transmit, via the transceiver, one or more UL sounding reference signals (SRSs) based on the one or more UL SRS configurations.

2. The UE of claim 1, wherein:
the UE is a first UE; and
the plurality of DL PRS symbols in each slot are symbols reserved for a second UE.

3. The UE of claim 2, wherein the at least one capability of the UE regarding carrier phase positioning (CPP) measurements comprises a capability to estimate a position of the UE based on the CPP measurements.

4. The UE of claim 3, wherein the at least one capability of the UE regarding carrier phase positioning (CPP) measurements further comprises at least one of:
a first capability to estimate a position of the UE based on the CPP measurements and timing-based positioning measurements; or
a second capability to estimate a change in a position of the UE based on the CPP measurements.

5. The UE of claim 1, wherein:
the one or more DL PRS configurations further comprise:
a periodicity of the plurality of DL PRS symbols on a slot time level or a sub-slot time level; and
a number of the plurality of DL PRS symbols in each slot or the sub-slot level periodicity; or
the one or more UL SRS configurations further comprise:
a periodicity of a plurality of UL SRS symbols on a slot time level or a sub-slot time level; and
a number of the plurality of UL SRS symbols in each slot or a sub-slot level periodicity; or
the one or more DL PRS configuration further comprise:
the plurality of DL PRS symbols for the CPP measurements having a higher periodicity in comparison to a plurality of DL PRS symbols for non-CPP measurements; or
the one or more UL SRS configuration further comprise:
the plurality of UL SRS symbols for the CPP measurements having a higher periodicity in comparison to a plurality of UL PRS symbols for non-CPP measurements.

6. The UE of claim 1, wherein the plurality of DL PRS symbols or a plurality of UL SRS symbols of the one or more UL SRS configurations are allocated in a comb-based pattern in time.

7. The UE of claim 1, wherein the plurality of DL PRS symbols or a plurality of UL SRS symbols of the one or more UL SRS configurations are allocated in a non-comb-based pattern.

8. The UE of claim 1, wherein:
the plurality of DL PRS symbols comprise one or more DL PRS symbols for timing-based positioning measurements, and one or more DL PRS symbols for the CPP measurements; and
the one or more DL PRS symbols for the timing-based positioning measurements are in a bandwidth part that is different from a bandwidth part of the one or more DL PRS symbols for the CPP measurements.

9. The UE of claim 1, wherein the one or more DL PRS configurations or the one or more UL SRS configurations include a first sub-configuration associated with timing-based positioning measurements, and a second sub-configuration associated with the CPP measurements.

10. The UE of claim 9, wherein:
the first sub-configuration defines a first time periodicity or a first frequency bandwidth for the timing-based positioning measurements;
the second sub-configuration defines a second time periodicity or a second frequency bandwidth for the CPP measurements; and
the first time periodicity or the first frequency bandwidth is larger than the second time periodicity or the second frequency bandwidth.

11. The UE of claim 10, wherein the second time periodicity or the second frequency bandwidth is a subset of the first time periodicity or the first frequency bandwidth.

12. The UE of claim 1, wherein:
the one or more DL PRS configurations include a first PRS configuration for timing-based positioning measurements and a second PRS configuration for the CPP measurements;
the first PRS configuration describes a first resource for the timing-based positioning measurements, and the second PRS configuration describes a second resource for the CPP measurements; and
the first resource is separate from the second resource.

13. The UE of claim 12, wherein the first resource and the second resource are in the same downlink (DL) PRS positioning frequency layer or different DL PRS positioning frequency layers.

14. The UE of claim 11, wherein:
a plurality of UL SRS symbols of the one or more UL SRS configurations comprise one or more UL PRS symbols for timing-based positioning measurements, and one or more UL SRS symbols for the CPP measurements; and
the one or more UL SRS symbols for the timing-based positioning measurements are in a bandwidth part that is different from a bandwidth part of the one or more UL SRS symbols for the CPP measurements.

15. The UE of claim 1, wherein:
the one or more UL SRS configurations include a first SRS configuration for timing-based positioning measurements and a second SRS configuration for the CPP measurements;
the first SRS configuration describes a first resource for the timing-based positioning measurements, and the second SRS configuration describes a second resource for the CPP measurements; and
the first resource is separate from the second resource.

16. The UE of claim 1, wherein:
the UE is a first UE; and
a plurality of UL SRS symbols of the one or more UL SRS configurations are symbols reserved for a second UE.

17. A base station, comprising:
a transceiver; and
a processor configured to,
receive, via the transceiver and from a user equipment (UE), UE capability information that indicates at least one capability of the UE regarding carrier phase positioning (CPP) measurements; and
in accord with the UE capability information:
transmit, via the transceiver and to the UE, one or more downlink (DL) positioning reference signal (PRS) configurations or one or more uplink (UL) sounding reference signal (SRS) configurations, the one or more DL PRS configurations or the one or more UL SRS configurations adapted for the CPP measurements, the one or more DL PRS configurations comprising a plurality of DL PRS symbols; and at least one of:
receive, via the transceiver and from the UE, the CPP measurements performed on the plurality of DL PRS symbols, the CPP measurements comprising carrier phase of the signal on arrival (CPoA) measurements and carrier phase difference of the signal of arrival (CPDoA); or
receive, via the transceiver and from the UE, one or more UL sounding reference signals (SRSs) based on the one or more UL SRS configurations.

18. A method, comprising:
transmitting, from a user equipment (UE) to a base station, UE capability information that indicates at least one capability of the UE regarding carrier phase positioning (CPP) measurements;
receiving, at the UE and from the base station, one or more downlink (DL) positioning reference signal (PRS) configurations adapted for carrier phase positioning (CPP) measurements, the one or more DL PRS configurations comprising a plurality of DL PRS symbols; and
performing the CPP measurements on the plurality of DL PRS symbols, the CPP measurements comprising carrier phase of the signal on arrival (CPoA) measurements and carrier phase difference of the signal of arrival (CPDoA).

19. The method of claim 18, further comprising:
receiving, at the UE and from the base station, one or more uplink (UL) sounding reference signal (SRS) configurations adapted for the CPP measurements by the base station, the one or more UL SRS configurations comprising a plurality of UL PRS symbols; and
in accord with receiving the one or more UL SRS configurations, transmitting, via the transceiver and to the base station, one or more uplink (UL) sounding reference signals (SRSs) adapted for the CPP measurements by the base station.

20. The method of claim 18, wherein:
the at least one capability of the UE regarding carrier phase positioning (CPP) measurements comprises a capability to estimate a position of the UE based on the CPP measurements.
